(19) United States
(12) Patent Application Publication
(10) Pub. No.: US 2014/0022631 A1
(43) Pub. Date: Jan. 23, 2014

(54) MICROSCOPE SLIDE FOR SPECIMEN TRACKING AND VERIFICATION, AND METHOD OF MAKING SAME

(71) Applicant: General Data Company, Inc., Cincinnati, OH (US)

(72) Inventors: Jack E. Hunnell, Hillsborough, NC (US); Kenneth Dean Marzinsky, Chapel Hill, NC (US)

(21) Appl. No.: 13/948,095

(22) Filed: Jul. 22, 2013

Related U.S. Application Data
(60) Provisional application No. 61/674,333, filed on Jul. 21, 2012.

(51) Int. Cl. G02B 21/34

(52) U.S. Cl. CPC G02B 21/34
USPC 359/396; 427/164

(57) ABSTRACT

A microscope slide article that is processable for color-contrasting marking thereof. The article includes a microscope slide with a main surface including an end surface portion, to which contrast coating material is applied. Various modes of processing are described for the contrast coating material, which are effective to produce color-contrast indicia on the slide, e.g., alphanumeric characters, barcodes, etc. that enable tracking and verification of the slides and specimens mounted thereon.

### CROSS-REFERENCE TO RELATED APPLICATION

This application claims the benefit under 35 USC §119 of U.S. Provisional Patent Application No. 61/674,333, filed on Jul. 21, 2012. The disclosure of U.S. Provisional Patent Application No. 61/674,333 is hereby incorporated herein by reference in its entirety, for all purposes.

### FIELD OF THE DISCLOSURE

The present disclosure relates to microscope slides including a marginal region that can be processed to provide color-contrasting marking indicia for specimen verification and tracking in various applications, including, without limitation, histology, botany, horticulture, plant biotechnology, and pathology. The disclosure further relates to methods of making and using such microscope slides.

### DESCRIPTION OF THE RELATED ART

Microscope slides are commonly used as substrates for mounting of biological specimens of widely varied type. In the fields of histology and pathology, tissue samples may be subjected to cryoprocessing, sectioning, staining, etc. and placed on glass slides so that the tissue can be microscopically analyzed. Ensuring proper identification of resulting samples on microscope slides is vital to ensure that the samples are identifiable to corresponding patients with absolute accuracy, and to maintain trackability of the slide-mounted specimens in their passage from biopsy facilities to tissue processing/slide mounting, and thereafter to histology/pathology analysis and final disposition of specimens.

To achieve reliable specimen verification and tracking capability, slides have historically been labeled or otherwise marked in a variety of ways. Handwritten marking of slides, using pencils, marker pens or other writing implements, has been common practice, but introduces issues of legibility and permanency, and is ill-suited to the needs of high-volume processing in modern histology and pathology facilities.

A variety of marking systems has been developed.

U.S. Pat. No. 5,919,553 (Kavanaugh) discloses a microscope slide with a marking area comprised of a layer of epoxy resin for inscription of a barcode. A laser is employed to inscribe the barcode in the marking area, leaving an opaque inscription.

U.S. Pat. No. 5,598,295 (Olofson) describes a microscope slide with a marking area comprising an epoxy resin on a top surface of the slide and a contrasting color on a bottom surface of the slide so that removal of material from the top surface provides a contrasting marking.

### SUMMARY OF THE DISCLOSURE

The present disclosure relates to microscope slides including a marginal region that can be processed to provide color-contrasting marking indicia for specimen verification and tracking of specimens mounted on such slide. The disclosure further relates to methods of making and using such microscope slide.

In one aspect, the disclosure relates to a microscope slide article that is processable by material removal or transformation for marking thereof with indicia for tracking and verification, said microscope slide article comprising:

a microscope slide comprising a main surface including an end surface portion; and
a color-contrast marking system on the end surface portion, wherein the color-contrast marking system is selected from among:
(a) color-contrast systems including: a first contrast coating on the end surface portion; and a second contrast coating on the first contrast coating, wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas;
(b) color-contrast systems including: a first contrast coating on the end surface portion; and a second contrast coating on the first contrast coating, wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings; and
(c) color-contrast systems including: a contrast coating on the end surface portion, and the microscope slide being of a contrasting color to the contrast coating, and the contrast coating being responsive to selective removal of contrast coating material, to form indicia defined by areas of removed contrast coating material and bounded by non-removed areas of contrast coating material, wherein the removed material areas of the contrast coating exposes areas of main surface of the microscope slide that color contrast with the contrast coating.

Another aspect of the disclosure relates to labeled microscope slide articles of the foregoing various types, which have been processed to form color-contrasting indicia for the microscope slide article.

Another aspect of the disclosure relates to a method of fabricating a microscope slide article that is processable by material removal for marking thereof, said method comprising:

providing a microscope slide comprising a main surface including an end surface portion;
depositing on the end surface portion a first contrast coating; and
depositing on said first contrast coating a second contrast coating,
wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas.

A further aspect of the disclosure relates to a method of processing a specimen for analysis thereof, said method comprising:

providing a microscope slide article comprising a color-contrast marking system (a) as described hereinabove;
selectively removing the second contrast coating material and the first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas; and
mounting said specimen on a medial portion of the main surface of the slide, before or after said indicia are formed.

Yet another aspect of the disclosure relates to a method of fabricating a microscope slide article that is processable for marking thereof, said method comprising:

providing a microscope slide comprising a main surface including an end surface portion;
depositing on the end surface portion a first contrast coating; and
depositing on said first contrast coating a second contrast coating,
wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings.

A still further aspect of the present disclosure relates to a method of processing a specimen for analysis thereof, said method comprising:

providing a microscope slide article comprising a color-contrast marking system (b) as described hereinabove;
selectively transforming at least one of the first and second contrast coatings by a transformation modality selected from among radiation exposure, pH change, chemical reaction, and etch removal of contrast coating material, to form indicia in the contrast coating material demarcated by color contrast of material in the first and second contrast coatings; and
mounting said specimen on a medial portion of the main surface of the slide, before or after said indicia are formed.

The disclosure relates in another aspect to a method of fabricating a microscope slide article that is processable for marking thereof, said method comprising:

providing a microscope slide comprising a main surface including at least an end surface portion that is contrast colored;
depositing on the end surface portion a contrast coating to which the microscope slide end surface portion is contrast colored, and which is selectively removable to form indicia defined by areas of removed contrast coating material and bounded by non-removed areas of contrast coating material, when the removed material areas of the contrast coating exposes areas of main surface of the microscope slide that color contrast with the contrast coating.

Another aspect of the present disclosure relates to a method of processing a specimen for analysis thereof, said method comprising:

providing a microscope slide article comprising a color-contrast marking system (c) as described hereinabove;
selectively removing the contrast coating to form indicia defined by areas of removed contrast coating material and bounded by non-removed areas of contrast coating material, so that the removed material areas of the contrast coating expose areas of main surface of the microscope slide that color contrast with the contrast coating; and
mounting said specimen on a medial portion of the main surface of the slide, before or after said indicia are formed.

Additional aspects, features, and embodiments of the disclosure will be more fully apparent from the ensuing description and appended claims.

### BRIEF DESCRIPTION OF THE DRAWINGS

FIG. 1 is a top plan view of a microscope slide article according to one embodiment of the present disclosure, after inscription of indicia thereon.

FIG. 2 is an elevation view of the microscope slide article of FIG. 1, along a longitudinally extending edge thereof, showing the constituent layers of the inscription coating system.

FIG. 3 is a top plan enlarged view of an end portion of the microscope slide article depicted in FIG. 1, showing the details thereof.

FIG. 4 is an edge elevation view of a microscope slide article according to another embodiment of the present disclosure, being processed to form color-contrast indicia thereon.

FIG. 5 is a top plan view of a portion of the FIG. 4 microscope slide article after formation of color-contrast indicia thereon.

FIG. 6 is a side elevation view of microscope slide article according to a further embodiment of the present disclosure, being processed to form color-contrast indicia thereon.

FIG. 7 is a top plan view of a portion of the microscope slide article of FIG. 6 after formation of color-contrast indicia thereon.

### DETAILED DESCRIPTION OF THE DISCLOSURE, AND PREFERRED EMBODIMENTS THEREOF

The present disclosure relates to a microscope slide article including a coating system at a marginal region thereof, which is processable to provide color-contrast indicia for identification and tracking of the slide and a specimen mounted on a medial region of the slide. The disclosure further relates to methods of making and using such microscope slides.

The disclosure relates in one aspect to a microscope slide article that is processable by material removal or transformation for marking thereof with indicia for tracking and verification, said microscope slide article comprising:

a microscope slide comprising a main surface including an end surface portion; and
a color-contrast marking system on the end surface portion, wherein the color-contrast marking system is selected from among:
(a) color-contrast systems including: a first contrast coating on the end surface portion; and a second contrast coating on the first contrast coating, wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas;
(b) color-contrast systems including: a first contrast coating on the end surface portion; and a second contrast coating on the first contrast coating, wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings; and
(c) color-contrast systems including: a contrast coating on the end surface portion, and the microscope slide being of a contrasting color to the contrast coating, and the contrast coating being responsive to selective removal of contrast coating material, to form indicia defined by areas of removed contrast coating material and bounded by non-removed areas of contrast coating material, wherein the removed material areas of the contrast coating exposes areas of main surface of the microscope slide that color contrast with the contrast coating.

In one arrangement of such microscope slide article, the color-contrast marking system comprises a color-contrast system (a) as described above. The first contrast coating may have a darker contrasting color in relation to the second contrast coating, e.g., a black contrast coating color. The second contrast coating may have a color such as pink, yellow, white, or gray. In specific embodiments, each of the first and second contrast coatings may have a same composition except colorant therein. For example, such same composition may comprise a polymeric composition, e.g., comprise a polymer selected from among acrylic polymers, polyurethanes, polyolefins, polyethylene terephthalate, fluoropolymers, silicones, polyimides, and polycarbonates.

The microscope slide may be formed of any suitable material, e.g., glass, polymeric or other material. The end surface portion of the main surface of the microscope slide may have a roughened character in relation to a medial portion of the main surface of the slide, e.g., as a result of being etched, sand-blasted, or otherwise processed to impart roughened character to the end surface portion on a surface thereof to be coated with contrast coating material.

The above-described microscope slide article can be labeled, by removing contrast coating material of the first and second contrast coatings from the slide to form identifying indicia for the microscope slide article. Such identifying indicia may comprise alphabetic characters, numeric characters, barcode indicia, or other indicia. The labeled slide may further comprise a specimen mounted at a medial portion of the main surface of the slide, e.g., a specimen selected from among: histology specimens that have been processed for microscopic visualization; human tissue specimens; human biopsy specimens; veterinary tissue specimens; and plant material specimens.

Alternatively, the microscope slide article described hereinabove may be arranged with the color-contrasting marking system comprising a color-contrast system (b). In such arrangement, the aforementioned transformation modality for forming the indicia may comprise radiation exposure, e.g., UV radiation, or a pH change, by exposure of the color-contrast system to an acidic or basic agent to effect the pH change that produces the indicia in the color-contrast system. Alternatively, the transformation modality may comprise chemical reaction wherein one or both of said contrast coatings is colorimetrically transformed by the chemical reaction. In yet another modality, etch removal of contrast coating material may be carried out using an etchant.

A labeled microscope slide article can be formed from such microscope slide article, including a transformed area wherein contrast coating material of the first and second contrast coatings has been transformed by the specific transformation modality to form identifying indicia for the microscope slide article. The identifying indicia may be of any suitable type, and may for example comprise alphabetic characters, numeric characters, barcode indicia, or any other suitable identifier or documenting indicia. A specimen may be mounted at a medial portion of the main surface of the microscope slide, e.g., a specimen selected from among: histology specimens that have been processed for microscopic visualization; human tissue specimens; human biopsy specimens; veterinary tissue specimens; and plant material specimens.

As a still further alternative, the microscope slide article described hereinabove may be arranged with the color-contrasting marking system comprising a color-contrast system (c). In such arrangement, the microscope slide may comprise glass that is colored at least at the end surface portion for contrast to the contrast coating material. For example, the microscope slide may be formed of colored or pigmented glass, or a polymeric or ceramic material that is colored at least at the end surface portion for contrast to the contrast coating material.

Such microscope slide article can be labeled by removal of contrast coating material from an area of the slide to form identifying indicia for the microscope slide article, e.g., alphabetic characters, numeric characters, barcoding, etc. The labeled slide article can be used to mount a specimen at a medial portion of the main surface of the slide, e.g., a specimen selected from among: histology specimens that have been processed for microscopic visualization; human tissue specimens; human biopsy specimens; veterinary tissue specimens; and plant material specimens.

The disclosure in one aspect contemplates a method of fabricating a microscope slide article that is processable by material removal for marking thereof, such method comprising:

providing a microscope slide comprising a main surface including an end surface portion;
depositing on the end surface portion a first contrast coating; and
depositing on said first contrast coating a second contrast coating,
wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas.

The disclosure relatedly contemplates a method of processing a specimen for analysis thereof, such method comprising:

providing a microscope slide article including a color-contrast system (a), as previously described herein;
selectively removing the second contrast coating material and the first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas; and
mounting said specimen on a medial portion of the main surface of the slide, before or after said indicia are formed.

Such method may be carried out wherein the selective removal comprises scribing the second contrast coating material and the first contrast coating material therebeneath for removal thereof to form the indicia. Alternatively, the selective removal may comprise lasing the second contrast coating material and the first contrast coating material therebeneath for removal thereof to form the indicia. A still further alternative for the selective removal comprises chemically etching the second contrast coating material and the first contrast coating material therebeneath for removal thereof to form the indicia.

In another aspect, the disclosure contemplates a method of fabricating a microscope slide article that is processable for marking thereof, said method comprising:

providing a microscope slide comprising a main surface including an end surface portion;
depositing on the end surface portion a first contrast coating; and
depositing on said first contrast coating a second contrast coating,
wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings.

In another aspect, the disclosure contemplates a method of processing a specimen for analysis thereof, such method comprising:

providing a microscope slide article including a color-contrast system (b) as previously described herein;
selectively transforming at least one of the first and second contrast coatings by a transformation modality selected from among radiation exposure, pH change, chemical reaction, and etch removal of contrast coating material, to form indicia in the contrast coating material demarcated by color contrast of material in the first and second contrast coatings; and
mounting the specimen on a medial portion of the main surface of the slide, before or after the indicia are formed.

The selective transformation in such method may be carried out in any of various suitable ways, including:

exposing at least one of the first and second contrast coatings to radiation effective to form indicia in the contrast coating material demarcated by color contrast of material in the first and second contrast coatings;
exposing at least one of the first and second contrast coatings to pH change effective to form indicia in the contrast coating material demarcated by color contrast of material in the first and second contrast coatings;
chemically reacting at least one of the first and second contrast coatings to form indicia in the contrast coating material demarcated by color contrast of material in the first and second contrast coatings; or
etch removing at least one of the first and second contrast coatings to form indicia in the contrast coating material demarcated by color contrast of material in the first and second contrast coatings.

In a further aspect, the disclosure contemplates a method of fabricating a microscope slide article that is processable for marking thereof, such method comprising:

providing a microscope slide comprising a main surface including at least an end surface portion that is contrast colored;
depositing on the end surface portion a contrast coating to which the microscope slide end surface portion is contrast colored, and which is selectively removable to form indicia defined by areas of removed contrast coating material and bounded by non-removed areas of contrast coating material, when the removed material areas of the contrast coating exposes areas of main surface of the microscope slide that color contrast with the contrast coating.

In another aspect, the disclosure contemplates a method of processing a specimen for analysis thereof, such method comprising:

providing a microscope slide article including a color-contrast system (c) as previously described herein;
selectively removing the contrast coating to form indicia defined by areas of removed contrast coating material and bounded by non-removed areas of contrast coating material, so that the removed material areas of the contrast coating expose areas of main surface of the microscope slide that color contrast with the contrast coating; and
mounting the specimen on a medial portion of the main surface of the slide, before or after the indicia are formed.

In a specific embodiment, the disclosure relates to a microscope slide article that is processable for making thereof, such microscope slide article comprising:

a microscope slide comprising a main surface including an end surface portion;
a coating material on the end surface portion that is processable to provide color-contrasted indicia, wherein such coating material is selected from the group consisting of:
(a) at least two contrast coating layers on said end surface portion, comprising a first contrast coating on the end surface portion; and
(b) a second contrast coating on said first contrast coating, wherein the first and second contrast coatings are of contrasting coloring relation to one another, and are responsive to scribing pressure exerted on the second contrast coating so that second contrast material and first contrast coating material there beneath are scribingly removed from the microscope slide, to form a scribed area on the main surface of the slide that is bounded by scribed edges of the first and second contrast coatings having sufficient misregistration of first contrast coating scribed edges and second contrast coating scribed edges so that they form a color-contrasting boundary of the scribed area as at least part of said indicia;
(c) a contrast coating on said end surface portion, and the microscope slide at said end surface portion being of a color providing a color contrast when material is removed from said contrast coating to form said indicia.

As will be appreciated from the foregoing discussion, the coating system on the end surface portion of the slide may comprise material that is removable in any of various suitable manners. For example, the coating material, or selected layers thereof, can be removed by scribing pressure exerted with a scribing instrument. The scribing instrument may be manually manipulated, or may be automated in character. The coating material on the end surface portion in other embodiments may be removable or transformable by radiation exposure, e.g., radiation exposure inducing a colorimetric change in the coating material or constituent layer(s) thereof to form a visually contrasting mark for the aforementioned indicia. In other embodiments, the contrast may be elicited from the contrast coating material by acid etch or other removal technique. In still other embodiments, the contrast material may be treated by inducing a chemical reaction that results in a color contrasting visual appearance of the associated indicia formed on the contrast coating material on the end surface portion of the microscope slide.

The microscope slide article thus may be formed of transparent or translucent material, and comprise a main surface including an end surface portion, with a first contrast coating on the end surface portion, and a second contrast coating on said first contrast coating, wherein the first and second contrast coatings are of contrasting color in relation to one another, and are responsive to scribing pressure exerted on the second contrast coating so that second contrast coating material and first contrast coating material therebeneath are scribingly removed from the microscope slide, to form a scribed area on the main surface of the slide that is bounded by scribed edges of the first and second contrast coatings having sufficient misregistration of first contrast coating scribed edges and second contrast coating scribed edges so that they form a color-contrasting boundary of the scribed area.

The microscope slide can be fabricated with the first contrast coating having a darker or lighter contrasting color in relation to the second contrast coating. For example, the first contrast coating may be black in color. The second contrast coating may have any suitable color that effects a contrast with the first contrast coating. In specific embodiments, the second contrast coating may for example have a color selected from the group consisting of pink, yellow, white, and gray.

The microscope slide can be constituted with each of the first and second contrast coatings having a same composition except for colorant therein, so that the first and second contrast coatings are visually differentiable from one another. When a same contrast coating composition is used in each of the first and second contrast coatings, except for the different coloration thereof, such same contrast coating composition may comprise a polymeric composition. Polymeric compositions of diverse types may be employed. The polymeric compositions may for example comprise polymer selected from the group consisting of acrylic polymers, polyurethanes, polyolefins, polyethylene terephthalate, fluoropolymers, silicones, polyimides, and polycarbonates. In various embodiments, the polymeric composition may comprise an acrylic polymer.

The microscope slide may be formed of any suitable material, and may for example be formed of glass or a polymeric material. The slide is preferably formed of a transparent or translucent material, for inspection and analytical use of the slide involving microscopy, e.g., optical microscopy, photomicroscopy, etc. The disclosure nonetheless contemplates the use of slides made of opaque or otherwise non-light-transmissive material. As indicated hereinabove, the slide may be colored, such as by incorporation of a dye or pigment therein, so that the slide itself forms a contrast substrate with the contrast material on the end surface portion thereof, such that removal of the contrast coating produces a color contrasting indicia on the end surface portion as a result of the material removal. Correspondingly, the microscope slide may be of a colored character, contrasting with the coating material on the end surface portion of the slide, whereby transformation of the coating, such as by selective etching, chemical reaction, etc. is carried out to form letters, numbers, bar codes, or other identifying indicia.

In addition to the foregoing modalities, the microscope slide may be constituted such that a pH change can be employed to create the color-contrasted indicia for tracking and verification of the microscope slide and specimen disposed thereon. Accordingly, the slide at the end surface portion may be treated with an appropriate acidic or basic chemical reagent to effect pH change producing the color-contrasting indicia on the slide. For example, the color-contrasting material on the end surface portion of the slide may be printed with a print head using ink of an acidic or basic character that is active to change the pH of the color-contrasting material on the end surface portion of the slide, and to create a color-contrasting appearance of the areas contacted by the pH adjusting print head and characters, bar codes, etc. applied thereby to the microscope slide at such end surface portion.

It will therefore be apparent from the foregoing description that the microscope slide and contrast material on the end surface portion thereof may be constituted in a wide variety of ways, to correspondingly provide color contrasting indicia for identification of a specimen disposed on the slide.

Microscope slides in accordance with the present disclosure, in specific embodiments thereof, may be provided with an end surface portion of the main surface of the slide having a roughened character in relation to a medial portion of the main surface of the slide. Such roughened end surface portion of the slide may be etched, sandblasted, or otherwise processed to provide a roughened or matte surface.

The disclosure therefore contemplates a labeled slide article, comprising a microscope slide article of the disclosure including a processed area, e.g., a scribed area, or treated area, wherein contrast coating material has been treated or otherwise processed to form identifying indicia, e.g., wherein the color contrast material comprises first and second contrast coatings that have been removed from the slide to form localized identifying indicia for the microscope slide article. The identifying indicia may be of any suitable type, and may for example comprise alphabetic characters, numeric characters, barcodes, or other forms of inscriptions and indicia.

Such labeled microscope slide article may further comprise a biological, plant, or other specimen mounted at a medial portion of the main surface of the slide. The specimen may for example comprise a histology specimen that has been processed for microscopic visualization, such as a human tissue specimen, e.g., a human biopsy specimen, or a veterinary tissue specimen.

While the disclosure contemplates the utilization of microscope slides for use in histology and pathology applications involving biological specimens, the scope of the disclosure is not thus limited. Slides of the disclosure may be utilized for a variety of specimens other than biological tissue specimens. Examples include thin film electronic materials for research and quality assurance applications, paints and lacquers for restoration of fine art, forensics evidence, etc. In addition to biological specimens from animal sources, the specimens mounted on microscope slides of the present disclosure may include plant specimens, bacterial, fungal, and viral specimens, etc.

The disclosure provides a method of fabricating a microscope slide article that is processable by material removal or transformation for marking thereof. Such method may for example comprise applying to the end surface portion of the microscope slide a color-contrast material that is processable to form indicia, e.g., by radiation exposure, scribing or mechanical material removal, etch removal of coating material, chemical reaction to effect removal or colorimetric change providing color-contrasting indicia, or other mode of eliciting a color-contrasting material being deposited at a marginal portion of the microscope slide. For example, the method of fabricating a microscope slide article processable by material removal for marking thereof, may comprise:

providing a microscope slide comprising a main surface including an end surface portion;
depositing on the end surface portion a first contrast coating; and
depositing on said first contrast coating a second contrast coating,
wherein the first and second contrast coatings are of contrasting color in relation to one another, and are responsive to scribing pressure exerted on the second contrast coating so that second contrast coating material and first contrast coating material therebeneath are scribingly removed from the microscope slide, to form a scribed area on the main surface of the slide that is bounded by scribed edges of the first and second contrast coatings having sufficient misregistration of first contrast coating scribed edges and second contrast coating scribed edges so that they form a color-contrasting boundary of the scribed area.

As discussed hereinabove, the end surface portion of the main surface of the microscope slide may be treated to enhance adhesion of the color-contrast coating thereto, by treating comprising etching, sandblasting, etc.

The method of fabricating the microscope slide article may comprise specific curing steps for curing the first contrast coating after it is deposited on the end surface portion of the main surface of the microscope slide, and subsequently the second contrast coating that is coated on or otherwise over the first contrast coating. The contrast coating material may for example be curable by heat cure steps involving elevated temperature curing, radiation exposure of radiation-curable compositions, ambient exposure drying, and/or any other steps that may be effective to cure the specific contrast coating material employed.

The disclosure contemplates a method of processing a specimen to provide for tracking and verification thereof, in which the method comprises mounting the specimen on a medial portion of a main surface of a microscope slide article of the present disclosure. The processing of the microscope slide for such purpose may include removing or otherwise transforming contrast coating material on the end surface portion of the microscope slide. For example, when using first and second contrast coatings as the contrast coating material, the processing of the microscope slide may include removing contrast coating material of the first and second contrast coatings from the slide to form identifying indicia for the specimen, in which such removal is conducted before or after mounting of the specimen on the slide. The specimen may comprise a histology specimen that has been processed for microscopic visualization, e.g., a human tissue specimen such as a biopsy specimen, or a veterinary tissue specimen, or other biological or non-biological specimen, in various embodiments of the disclosure.

The identifying indicia formed in the contrast coating material may as previously discussed comprise alphabetic characters, numeric characters, alphanumeric characters, barcode indicia, etc. Such identifying indicia can be formed by removal of the contrast coating material so that the edges of the associated non-removed material are jaggedly differential in the respective first and second contrast coatings, when separate layers of contrasting material are applied, so that the edge has a visually distinctive appearance demarcating the characters, features, patterns, etc. of the indicia for identifying a sample previously or thereafter mounted on the slide for visual identification, or wherein the indicia are otherwise susceptible to machine recognition, e.g., by barcode readers, optical scanners, etc., or other modality for utilizing the indicia for tracking and verification of the slide and the specimen thereon.

The removal of the contrast coating material may be effected in any manner. In instances in which the contrast coating material comprises multiple layers of contrasting material, e.g., overlying and underlying layers of contrasting color, the removal of the contrast coating material may be carried out, and may comprise use of a scribing tool, such as a scribing stylus that is scribingly translated across the coating material to penetrate coating material and remove the first and second contrast layers in such manner as to provide the visually discernible indicia, by differential edge exposure of the first and second contrast layers in relation to one another at the boundary between the removed coating material in the non-removed coating material. Alternatively, the contrast coating material may be processed by chemical removal, chemical reaction, or other removal or transformation of the material to form a color-contrasting set of appropriate indicia for identification of the slide and its contents.

In embodiments in which the contrast coating material comprises multiple layers, e.g. first and second contrast coating layers, the first and second contrast coating layers desirably exhibit sufficient interlayer adhesion to permit ready concurrent removal of the first and second layer material at the site of the indicia, while the first contrast coating layer should have sufficient adhesion to the main surface of the microscope slide to enable permanent identification and structural integrity of the indicia formed on the slide in the coating material. In other embodiments, in which the contrast coating material is deposited on the microscope slide end surface portion, the contrast coating material should have sufficient adhesion to the surface of the microscope slide to sustain subsequent processing to form identifying indicia on the slide in the contrast coating material or with the aid of the contrast coating material, such as where the contrast coating material is of contrasting color to a pigmented or otherwise colored slide.

The contrast coating material in the areas thereof that are not processed or removed to form identifying indicia may be of a character that can be manually marked by a writing instrument, such as a pencil or marker instrument, as a further feature of the contrast coating.

In one specific embodiment of the disclosure, the contrast coating material is provided in respective first and second contrast coating layers on the microscope slide end surface portion. In such embodiment, the contrast coating material utilized in each of the first and second contrast coatings on the microscope slide comprises Glass and Metal Ink 8000, commercially available from Taizhou Mebon New Materials Co. (China), having the composition Specified below in Table 1. It is noted that the respective first and second contrast coating formulations will differ in color, so that in one of the contrast coating formulations, the colorant will be carbon black at a concentration of 21% by weight, based on total weight of the composition, and wherein the other of the contrast coating formulations will contain carbon black at 8% by weight, on the same total weight basis, together with a further colorant selected from among green, yellow, blue, red, and white (titanium dioxide) colors, in an amount of 13% weight, based on total weight of the composition.

TABLE 1
Glass and Metal Ink 8000 Composition

| Component | Weight (%) |
|---|---|
| Acid, Dimethyl, Nylon | 15% |
| 3,5,5-Trimethyl-2-cyclohexen-1- | 15% |
| one | |
| Barium, sulfate | 10% |
| Carbon black | 8% |
| Dimethyl 2-(4-methoxyphenyl) | 5.2% |
| succinate | |
| Dimethyl adipate | 5% |
| Dimethyl glutarate | 5% |
| Colorant, selected from among | 13% |
| black (carbon black), white | |
| (titanium dioxide), green, yellow, | |
| red, and blue pigment colorants | |
| Acrylic resin | 23% |
| Silicone Polyether | 0.8% |

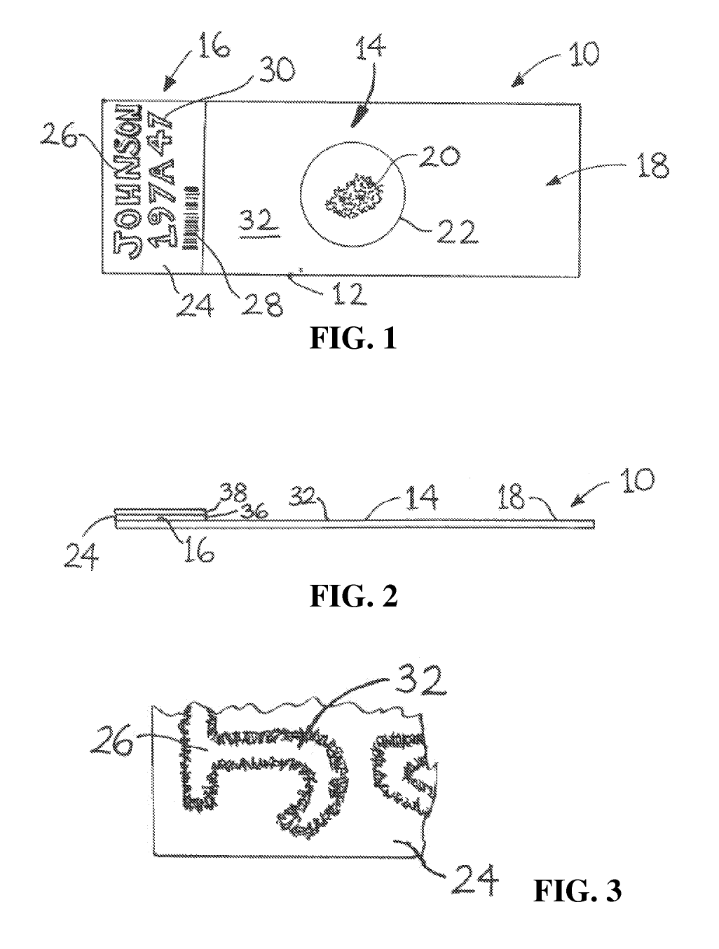

Referring now to the drawings, FIG. 1 is a top plan view of a microscope slide article 10 according to one embodiment of the present disclosure, after inscription of indicia 26, 28, 30 thereon. The article comprises a microscope slide 12 having a main top surface 32, with a left-hand marginal region 16, right-hand marginal region 18, and medial region 14.

The medial region 14 of the slide has disposed thereon a tissue sample 20 under a coverslip 22 securing the tissue sample in position. The tissue sample may comprise a biopsy tissue specimen that has been sectioned and stained for histological analysis.

The left-hand marginal region 16 of the microscope slide 12 has a contrast coating 24 thereon, in which has been scribingly formed a patient name in alphabetic characters 26, a patient alphanumeric identifier 30, and a corresponding barcode 28.

FIG. 2 is an elevation view of the microscope slide article 10 of FIG. 1, along a longitudinally extending edge thereof, showing the constituent layers of the inscription coating system of the present disclosure. The contrast coating 24 is seen to have a first contrast coating layer 36 and a second contrast coating layer 38 on the marginal portion 16 of the slide, on the main top surface 32 thereof. The view of the slide article 10 in FIG. 2 shows the medial region 14 without the tissue sample 20 and coverslip 22 shown in FIG. 1.

FIG. 3 is a top plan enlarged view of an end portion of the microscope slide depicted in FIG. 1, showing the details thereof. As illustrated, the contrast coating 24 has been scribed to remove the first and second contrast coating layers and expose the top main surface 32 of the slide, so that the marking indicia comprise an exposed surface area of the slide, bounded by the jagged edge portions of the respective first and second contrast coating layers, in which the darker first (bottom) layer is sufficiently jaggedly protrusive along the periphery of the individual alphanumeric characters as to form a contrasting border of the respective characters, so that they are readily visually discernible. Such peripheral edge formation of the scribed indicia characters may be utilized to form machine-readable characters or patterns such as the barcode 28 shown in FIG. 1.

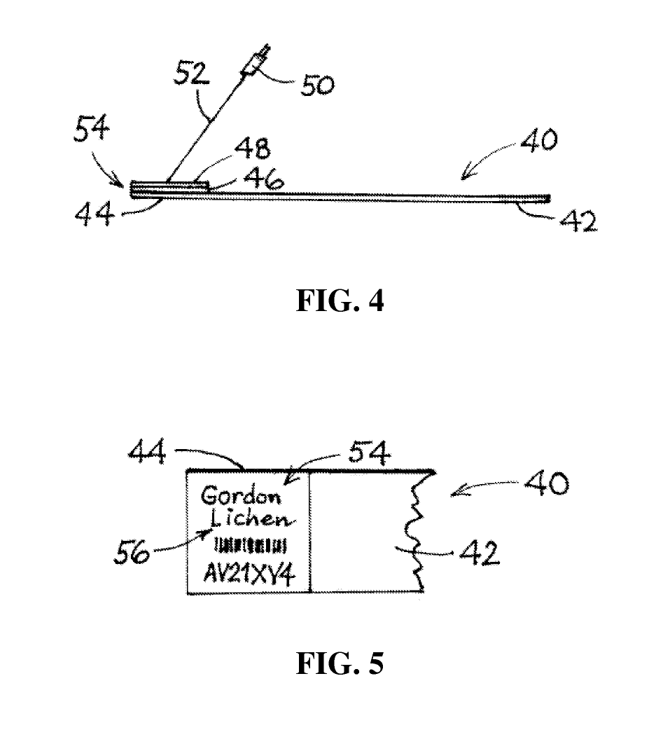

FIG. 4 is an edge elevation view of a microscope slide article 40 according to another embodiment of the present disclosure, being processed to form color-contrast indicia thereon. The microscope slide article 40 includes microscope slide 42 having an end portion 44 on the top surface of which is disposed a color-contrast system 54 including first contrast coating 46 and second contrast coating 48. The color-contrast system 54 is illustrated as being irradiated by ultraviolet radiation 52 from UV source 50. The UV radiation effects cross-linking of material in one of the first and second contrast coatings 46 and 48 of the color-contrast system at areas impinged by the UV radiation beam, to effect a colorimetric change of the irradiated areas, to form indicia in the contrast coating material demarcated by color contrast material in the first and second contrast coatings. For such purpose, the corresponding contrast coating may be any suitable material that in exposure to UV radiation is effective to produce a colorimetric change that is visually discernible to produce indicia such as shown in FIG. 5.

FIG. 5 is a top plan view of a portion of the FIG. 4 microscope slide article 40 after formation of color-contrast indicia 56 thereon. As illustrated, the indicia may include a patient name, corresponding barcode and alphanumeric identifier indicia at the end portion 44 of the slide 42 in the color-contrast system 54.

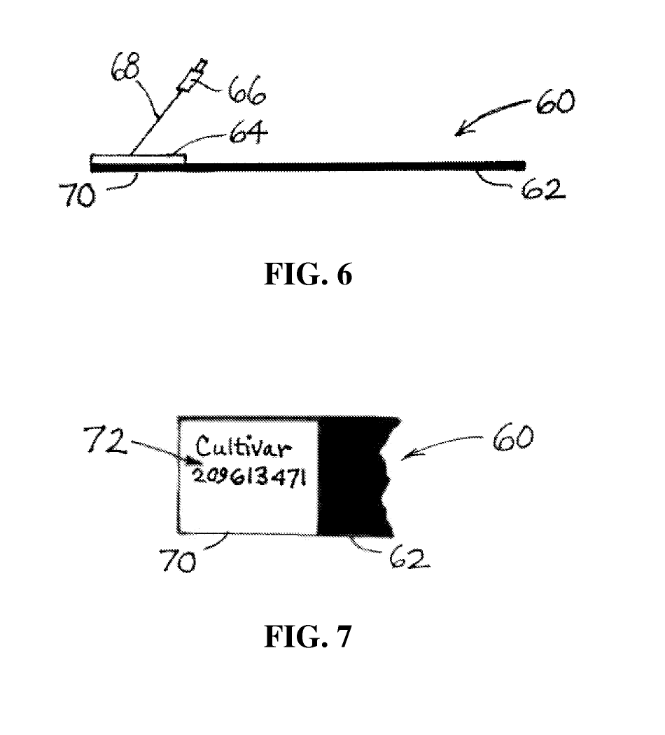

FIG. 6 is a side elevation view of microscope slide article 60 according to a further embodiment of the present disclosure, being processed to form color-contrast indicia thereon. The microscope slide article 60 includes a microscope slide 62 that is of a dark color in relation to the color-contrast system contrast coating 64 deposited on the top surface at the end portion 70 of the microscope slide, as illustrated. In the view shown, the color-contrast system contrast coating 64 is being irradiated with a laser beam 68 from laser 66, so that the lased areas of the contrast coating 64 are removed by ablation, to form the indicia defined by areas of removed contrast coating material and bounded by non-removed areas of contrast coating material, wherein the removed material areas of the contrast coating exposes areas of main surface of the microscope slide that color contrast with the contrast coating, as shown in FIG. 7.

FIG. 7 is a top plan view of a portion of the microscope slide article 60 of FIG. 6 after formation of color-contrast indicia 72 thereon at the end portion 70 of the microscope slide 62. By removal of the lighter-colored contrast coating, the indicia are formed by the resultant bare areas of exposed surface of the darker colored microscope slide.

While the disclosure has been has been described herein in reference to specific aspects, features and illustrative embodiments of the disclosure, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

What is claimed is:

1. A microscope slide article that is processable by material removal or transformation for marking thereof with indicia for tracking and verification, said microscope slide article comprising:
a microscope slide comprising a main surface including an end surface portion; and
a color-contrast marking system on the end surface portion, wherein the color-contrast marking system is selected from among:
(a) color-contrast systems including: a first contrast coating on the end surface portion; and a second contrast coating on the first contrast coating, wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas;
(b) color-contrast systems including: a first contrast coating on the end surface portion; and a second contrast coating on the first contrast coating, wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings; and
(c) color-contrast systems including: a contrast coating on the end surface portion, and the microscope slide being of a contrasting color to the contrast coating, and the contrast coating being responsive to selective removal of contrast coating material, to form indicia defined by areas of removed contrast coating material and bounded by non-removed areas of contrast coating material, wherein the removed material areas of the contrast coating exposes areas of main surface of the microscope slide that color contrast with the contrast coating.

2. The microscope slide article of claim 1, wherein the color-contrast marking system comprises a color-contrast system (a).

3. The microscope slide article of claim 2, wherein the first contrast coating has a darker contrasting color in relation to the second contrast coating.

4. The microscope slide article of claim 3, wherein the first contrast coating has a black color.

5. The microscope slide article of claim 2, wherein each of the first and second contrast coatings has a same composition except colorant therein.

6. The microscope slide article of claim 5, wherein said same composition comprises a polymeric composition.

7. The microscope slide article of claim 6, wherein said polymeric composition comprises an acrylic polymer.

8. The microscope slide article of claim 2, wherein said end surface portion of the main surface of the microscope slide has a roughened character in relation to a medial portion of the main surface of the slide.

9. The microscope slide article of claim 1, wherein the color-contrast marking system comprises a color-contrast system (b).

10. The microscope slide article of claim 9, wherein the transformation modality is radiation exposure.

11. The microscope slide article of claim 10, wherein the radiation exposure comprises ultraviolet radiation.

12. The microscope slide article of claim 9, wherein the transformation modality is pH change.

13. The microscope slide article of claim 9, wherein the transformation modality is chemical reaction wherein one or both of said contrast coatings is colorimetrically transformed by the chemical reaction.

14. The microscope slide article of claim 9, wherein the transformation modality is etch removal of contrast coating material using an etchant.

15. The microscope slide article of claim 1, wherein the color-contrast marking system comprises a color-contrast system (c).

16. The microscope slide article of claim 15, wherein the microscope slide comprises glass that is colored at least at the end surface portion for contrast to the contrast coating material.

17. The microscope slide article of claim 15, wherein the microscope slide comprises a polymeric or ceramic material that is colored at least at the end surface portion for contrast to the contrast coating material.

18. A method of fabricating a microscope slide article that is processable by material removal for marking thereof, said method comprising:
providing a microscope slide comprising a main surface including an end surface portion;
depositing on the end surface portion a first contrast coating; and
depositing on said first contrast coating a second contrast coating,
wherein the first and second contrast coatings are of contrasting color in relation to one another, and are responsive to selective removal of second contrast coating material and first contrast coating material therebeneath, to form indicia defined by areas of removed first and second contrast coating materials and bounded by non-removed areas of first and second contrast coating material, wherein the removed materials areas are bounded by edges of the first and second contrast coatings having sufficient misregistration of first contrast coating edges and second contrast coating edges so that they form a color-contrasting boundary of the removed areas.

19. A method of fabricating a microscope slide article that is processable for marking thereof, said method comprising:
providing a microscope slide comprising a main surface including an end surface portion;
depositing on the end surface portion a first contrast coating; and
depositing on said first contrast coating a second contrast coating,
wherein at least one of the first and second coatings is transformable by a transformation modality selected from among radiation exposure, pH change, chemical reaction, and etch removal of contrast coating material, to form indicia in the contrast coating material demarcated by color contrast of material in the first and second contrast coatings.

20. A method of fabricating a microscope slide article that is processable for marking thereof, said method comprising:
providing a microscope slide comprising a main surface including at least an end surface portion that is contrast colored;
depositing on the end surface portion a contrast coating to which the microscope slide end surface portion is contrast colored, and which is selectively removable to form indicia defined by areas of removed contrast coating material and bounded by non-removed areas of contrast coating material, when the removed material areas of the contrast coating exposes areas of main surface of the microscope slide that color contrast with the contrast coating.
